(19) United States
(12) Patent Application Publication
(10) Pub. No.: US 2026/0155308 A1
(43) Pub. Date: Jun. 4, 2026

(54) MULTILAYER ELECTRONIC COMPONENT

(71) Applicant: SAMSUNG ELECTRO-MECHANICS CO., LTD., Suwon-si (KR)

(72) Inventors: Seok Jun CHAE, Suwon-si (KR); Si Eun LEE, Suwon-si (KR); Kyung Sik KIM, Suwon-si (KR)

(73) Assignee: SAMSUNG ELECTRO-MECHANICS CO., LTD., Suwon-si (KR)

(21) Appl. No.: 19/303,670

(22) Filed: Aug. 19, 2025

(30) Foreign Application Priority Data
Dec. 4, 2024 (KR) 10-2024-0178678

(51) Int. Cl. H01G 4/30; H01G 4/232

(52) U.S. Cl. CPC H01G 4/30; H01G 4/2325

(57) ABSTRACT

A multilayer electronic component includes a body including a dielectric layer and an internal electrode; and an external electrode including a first electrode layer disposed on the body and connected to the internal electrode, and a second electrode layer disposed on the first electrode layer; wherein, if regions of the external electrodes disposed on portions of upper and lower surfaces of the body are referred to as band portions, a ratio (BW/BL) of a maximum length BW of each of the band portions relative to an average length BL of the body satisfies 14.9%≤BW/BL<50.0%, and an average surface roughness (Ra1) of the body in a region of each of the band portions, in which the second electrode layer is disposed to contact the body, satisfies 0 nm<Ra1≤158 nm.

### CROSS-REFERENCE TO RELATED APPLICATION(S)

This application claims benefit of priority to Korean Patent Application No. 10-2024-0178678 filed on Dec. 4, 2024 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, may be a chip condenser mounted on the printed circuit boards of various types of electronic products such as image display devices including a liquid crystal display (LCD), a plasma display panel (PDP), or the like, a computer, a smartphone, a mobile phone, or the like, serving to charge or discharge electricity therein or therefrom.

Such a multilayer ceramic capacitor may be used as a component of various electronic devices, as the multilayer ceramic capacitor has a small size with high capacitance and may be easily mounted. As various electronic devices such as computers, mobile devices, or the like have been miniaturized and implemented with high-output, demand for miniaturization and high capacitance of multilayer ceramic capacitors has increased.

Meanwhile, multilayer ceramic capacitors for electric/electronic fields that require high voltage or high reliability require high bending strength characteristics because they should maintain high stability even under environments having strong vibrations or external impacts. The multilayer ceramic capacitors include a body formed of a ceramic material having high hardness and brittleness, as a component, to have a structure vulnerable to cracks due to external impact, and various structural designs capable of compensating for this are being applied.

### SUMMARY

One of the problems to be solved by the present disclosure is to provide a multilayer electronic component having improved bending strength characteristics.

One of the problems to be solved by the present disclosure is to provide a multilayer electronic component having enhanced impact resistance.

The various problems to be solved by the present disclosure are not limited to the above-described contents, and can be more easily understood in the process of explaining specific embodiments of the present disclosure.

According to an aspect of the present disclosure, a multilayer electronic component includes a body including a dielectric layer and an internal electrode alternately disposed with the dielectric layer in a first direction, and including first and second surfaces opposing each other in the first direction, third and fourth surfaces connected to the first and second surfaces and opposing each other in a second direction, and fifth and sixth surfaces connected to the first to fourth surfaces and opposing each other in a third direction; and an external electrode including a first electrode layer disposed on the body and connected to the internal electrode, and a second electrode layer disposed on the first electrode layer, wherein the external electrode includes a first external electrode disposed on the third surface and extending onto a portion of the first surface and a portion of the second surface, and a second external electrode disposed on the fourth surface and extending onto a portion of the first surface and a portion of the second surface, and, if regions of the first and second external electrodes extended to the portions of the first and second surfaces are referred to as band portions, a ratio (BW/BL) of a second direction maximum length BW of each of the band portions relative to a second direction average length BL of the body satisfies 14.9%≤BW/BL<50.0%, and each of the band portions includes a first region in which the second electrode layer is disposed to contact the body, and an average surface roughness (Ra1) of the body in the first region satisfies 0 nm<Ra1≤158 nm.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 schematically illustrates a perspective view of a multilayer electronic component according to an embodiment of the present disclosure.

FIG. 2 schematically illustrates an exploded perspective view illustrating a stack structure of internal electrodes.

FIG. 3 schematically illustrates a cross-sectional view of FIG. 1, taken along line I-I′.

FIG. 4 schematically illustrates an enlarged view of a P region of FIG. 3.

FIG. 5 schematically illustrates a cross-sectional view of FIG. 1, taken along line II-II′.

FIG. 6 schematically illustrates a cross-sectional view of FIG. 1, taken along line II-II′, according to another embodiment of the present disclosure.

### DETAILED DESCRIPTION

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes, sizes, and the like, of the elements in the drawings may be exaggerated for clarity of description, and the elements denoted by the same reference numerals in the drawings may be the same elements.

In addition, in order to clearly explain the present disclosure in the drawings, portions not related to the description will be omitted for clarification of the present disclosure, and a thickness may be enlarged to clearly illustrate layers and regions. The same reference numerals will be used to designate the same components in the same reference numerals. Further, throughout the specification, when an element is referred to as “comprising” or “including” an element, it means that the element may further include other elements as well, without departing from the other elements, unless specifically stated otherwise.

In the drawing, a first direction may be defined as a stack direction or a thickness T direction, a second direction may be defined as a length L direction, and a third direction may be defined as a width W direction.

### Multilayer Electronic Component

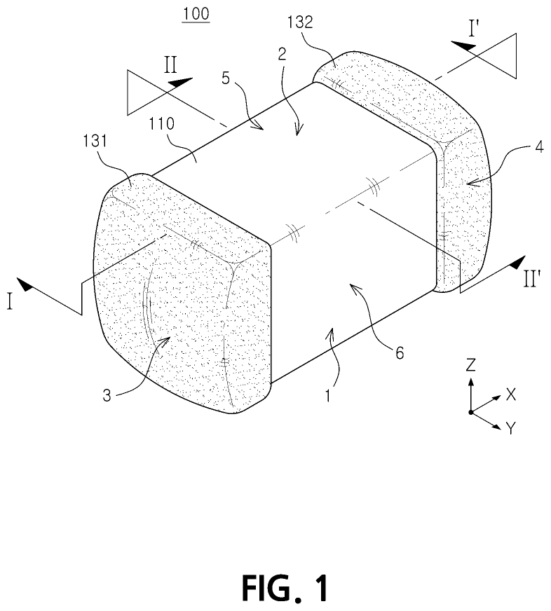

FIG. 1 schematically illustrates a perspective view of a multilayer electronic component according to an embodiment of the present disclosure.

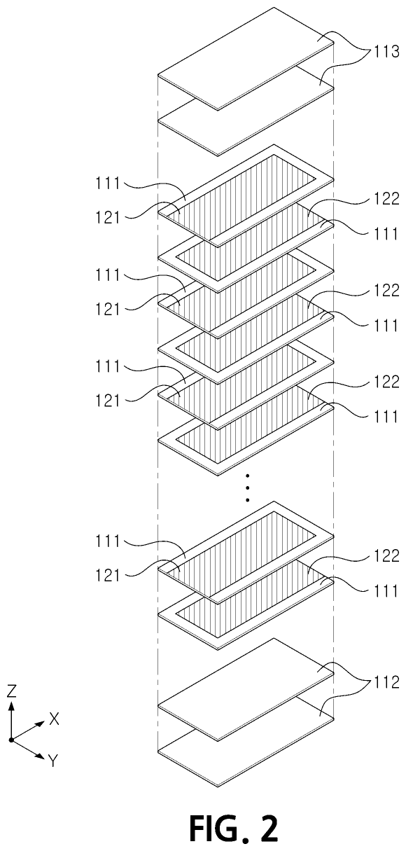

FIG. 2 schematically illustrates an exploded perspective view illustrating a stack structure of internal electrodes.

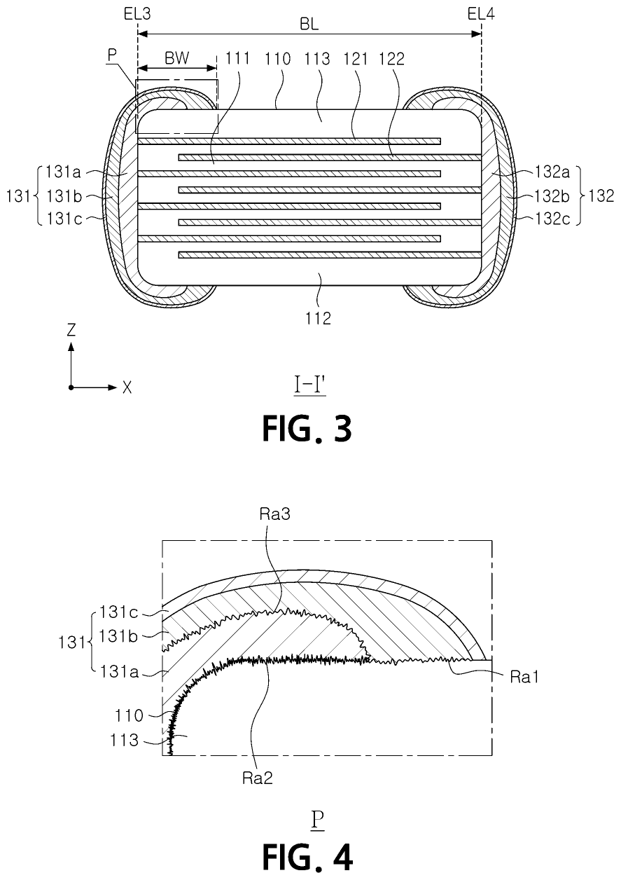

FIG. 3 schematically illustrates a cross-sectional view of FIG. 1, taken along line I-I′.

FIG. 4 schematically illustrates an enlarged view of a P region of FIG. 3.

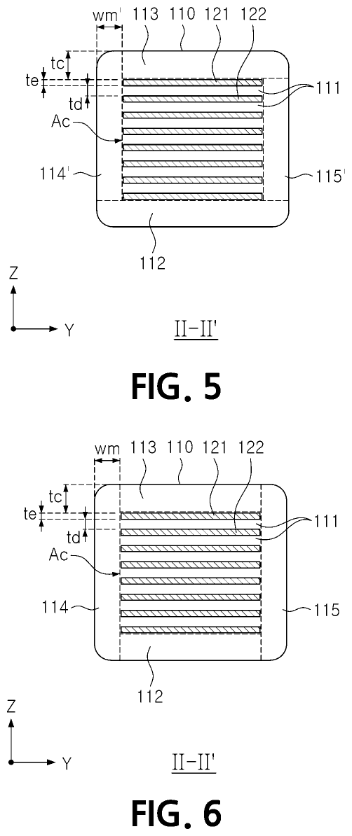

FIG. 5 schematically illustrates a cross-sectional view of FIG. 1, taken along line II-II′.

FIG. 6 schematically illustrates a cross-sectional view of FIG. 1, taken along line II-II′, according to another embodiment of the present disclosure.

Hereinafter, with reference to FIGS. 1 to 6, a multilayer electronic component according to some embodiments of the present disclosure will be described in detail. A multilayer ceramic capacitor will be described as an example of a multilayer electronic component, but the example embodiment may also be applied to various electronic products using a dielectric composition, such as an inductor, a piezoelectric element, a varistor, a thermistor, or the like.

According to some embodiments of the present disclosure, a multilayer electronic component 100 includes a body 110 including a dielectric layer 111 and an internal electrode (121 and 122) alternately disposed with the dielectric layer 111 in a first direction, and including first and second surfaces 1 and 2 opposing each other in the first direction, third and fourth surfaces 3 and 4 connected to the first and second surfaces and opposing each other in a second direction, and fifth and sixth surfaces 5 and 6 connected to the first to fourth surfaces 1, 2, 3, and 4 and opposing each other in a third direction; and an external electrode (131 and 132) including a first electrode layer (131a and 132a) disposed on the body 110 and connected to the internal electrode (121 and 122), and a second electrode layer (131b and 132b) disposed on the first electrode layer (131a and 132a), wherein the external electrode (131 and 132) includes a first external electrode 131 disposed on the third surface 3 and extending onto a portion of the first surface 1 and a portion of the second surface 2, and a second external electrode 132 disposed on the fourth surface 4 and extending onto a portion of the first surface 1 and a portion of the second surface 2, and, if regions of the first and second external electrodes 131 and 132 extended to the portions of the first and second surfaces are referred to as band portions, a ratio (BW/BL) of a second direction maximum length BW of each of the band portions relative to a second direction average length BL of the body 110 satisfies 14.9%≤BW/BL<50.0%, and each of the band portions includes a first region in which the second electrode layer (131b and 132b) is disposed to contact the body, and an average surface roughness (Ra1) of the body 110 in the first region satisfies 0 nm<Ra1≤158 nm.

The body 110 may have the dielectric layer 111 and internal electrode (121 and 122), alternately stacked.

More specifically, the body 110 may include a first internal electrode 121 and a second internal electrode 122, disposed in the body 110 and alternately disposed to face each other, with the dielectric layer 111 therebetween, to include a capacitance forming portion Ac that forms capacitance.

Although a specific shape of the body 110 is not particularly limited, the body 110 may have a hexahedral shape or the like, as illustrated. Due to shrinkage of ceramic powder particles included in the body 110 during a sintering process, the body 110 may not have a perfectly straight hexahedral shape, but may have a substantially hexahedral shape.

The body 110 may include first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first to fourth surfaces 1, 2, 3, and 4 and opposing each other in a third direction.

A plurality of dielectric layers 111 forming the body 110 may be in a sintered state, and a boundary between adjacent dielectric layers 111 may be integrated to such an extent that it may be difficult to identify the same without using a scanning electron microscope (SEM).

In the present disclosure, the second direction average length BL of the body 110 may be a second direction average length BL between the third surface 3 and the fourth surface 4, for example, a distance between an extension line EL3 of the third surface 3 and an extension line ELA of the fourth surface 4, parallel to each other, may be a second direction length BL or a second direction average length BL. However, the present disclosure is not limited thereto, and a more specific method of obtaining the second direction average length BL of the body 110 may be as follows: when the first and second direction cross-sections of the body 110 are observed with a scanning electron microscope (SEM), an average value of second direction lengths measured at a first direction center of the body 110 and second direction lengths measured at points spaced apart from the first direction center in both first directions by a certain interval may be the second direction average length BL of the body 110. A more specific description of the second direction average length BL of the body 110 will be given later.

A raw material for forming the dielectric layer 111 is not particularly limited, as long as sufficient capacitance may be obtained therewith. In general, a perovskite (ABO₃)-based material may be used, for example, a barium titanate-based material, a lead composite perovskite-based material, a strontium titanate-based material, or the like may be used. The barium titanate-based material may include a BaTiO₃-based ceramic powder, and examples of the ceramic powder may include BaTiO₃, or (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), or the like, in which calcium (Ca), zirconium (Zr), or the like is partially dissolved in BaTiO₃, or the like.

In addition, various ceramic additives, organic solvents, binders, dispersants, or the like may be added to the powder of barium titanate (BaTiO₃), and the like, as the raw material for forming the dielectric layer 111, according to the purpose of the present disclosure.

To distinguish the dielectric layer 111 included in the capacitance portion (Ac) from dielectric layers included in a cover portion (112 and 113) and a side margin portion (114 and 115), described later, a dielectric layer included in the capacitance forming portion Ac may be defined as a first dielectric layer, a dielectric layer included in the cover portion (112 and 113) may be defined as a second dielectric layer, and a dielectric layer included in the side margin portion (114 and 115) may be defined as a third dielectric layer.

In addition, the first to third dielectric layers may be formed using a dielectric material such as barium titanate (BaTiO₃), and may thus include a dielectric microstructure after sintering. The dielectric microstructure may include a plurality of grains, grain boundaries disposed between adjacent grains, and triple points disposed at points at which three or more grain boundaries meet, and the number of grains, grain boundaries, and triple points may be plural, respectively.

A first direction length td of the dielectric layer 111 is not limited thereto.

To secure reliability of the multilayer electronic component 100 under a high voltage environment, the first direction length td of the dielectric layer 111 may be 10 μm or less. In addition, to achieve miniaturization and high capacitance of the multilayer electronic component 100, the first direction length td of the dielectric layer 111 may be 3 μm or less. To more easily achieve miniaturization and high capacitance, the first direction length td of the dielectric layer 111 may be 1 μm or less, may be 0.6 μm or less, and may be 0.4 μm or less.

In this case, the first direction length td of the dielectric layer 111 may mean a first direction length td of a dielectric layer 111 disposed between the first and second internal electrodes 121 and 122.

The first direction length td of the dielectric layer 111 may mean a length, a distance, a size, a length, or the like of the dielectric layer 111 in the first direction, or may mean a thickness of the dielectric layer.

In this case, the first direction length td of the dielectric layer 111 may be a concept including a first direction length td of at least one of the plurality of dielectric layers 111, or may be a concept including a first direction length td of each of all the dielectric layers 111.

In addition, the first direction length td of the dielectric layer 111 may mean a first direction average length td of one dielectric layer 111, may mean a first direction average length td of each of the plurality of dielectric layers 111, or may mean a first direction average length td of the plurality of dielectric layers 111.

The first direction average length td of the dielectric layer 111 may be measured by scanning images of the first and second direction cross-sections of the body 110 with a scanning electron microscope (SEM) at 10,000× magnification. More specifically, the first direction average length td of one dielectric layer 111 may mean an average value calculated by measuring first direction lengths of one dielectric layer 111 at five (5) equally spaced points in the second direction in scanned images. The five (5) equally spaced points may be designated in the capacitance forming portion Ac. In addition, when this average value measurement is extended to three dielectric layers 111 to measure an average value, the first direction average length td of plurality of dielectric layers 111 may be further generalized.

The internal electrode (121 and 122) may be alternately stacked with the dielectric layer 111.

The internal electrode (121 and 122) may include a first internal electrode 121 and a second internal electrode 122, and the first and second internal electrodes 121 and 122 may be alternately disposed to face each other with the dielectric layer 111 forming the body 110 interposed therebetween, and may be exposed to the third and fourth surfaces 3 and 4 of the body 110, respectively.

More specifically, the first internal electrode 121 may be spaced apart from the fourth surface 4 and exposed through the third surface 3, and the second internal electrode 122 may be spaced apart from the third surface 3 and exposed through the fourth surface 4. A first external electrode 131 may be disposed on the third surface 3 of the body 110 and connected to the first internal electrode 121, and a second external electrode 132 may be disposed on the fourth surface 4 of the body 110 and connected to the second internal electrode 122.

For example, the first internal electrode 121 may be connected to the first external electrode 131 without being connected to the second external electrode 132, and the second internal electrode 122 may be connected to the second external electrode 132 without being connected to the first external electrode 131. In this case, the first and second internal electrodes 121 and 122 may be electrically separated from each other by the dielectric layer 111 disposed therebetween.

The body 110 may be formed by alternately stacking and then sintering a first ceramic green sheet on which a first internal electrode paste is printed and a second ceramic green sheet on which a second internal electrode paste is printed.

A material forming the internal electrode (121 and 122) is not particularly limited, and a material having excellent electrical conductivity may be used as the main component metal. For example, the internal electrode (121 and 122) may include one or more selected from the group consisting of nickel (Ni), copper (Cu), palladium (Pd), silver (Ag), gold (Au), platinum (Pt), tin (Sn), tungsten (W), titanium (Ti), and an alloy thereof.

In addition, the internal electrode (121 and 122) may be formed by printing a conductive paste for internal electrodes including one or more selected from the group consisting of nickel (Ni), copper (Cu), palladium (Pd), silver (Ag), gold (Au), platinum (Pt), tin (Sn), tungsten (W), titanium (Ti), and an alloy thereof on a ceramic green sheet. The printing method of the conductive paste for internal electrodes may use a screen printing method, a gravure printing method, or the like, and the present disclosure is not limited thereto.

A first direction length the of the internal electrode (121 and 122) is not limited thereto, and the following description of the first direction length the of the internal electrode (121 and 122) may mean a first direction length the of each of the first internal electrode 121 and the second internal electrode 122.

To secure reliability of the multilayer electronic component 100 under a high voltage environment, the first direction length the of the internal electrode (121 and 122) may be 3.0 μm or less. In addition, to achieve miniaturization and high capacitance of the multilayer electronic component 100, the first direction length the of the internal electrode (121 and 122) may be 1.0 μm or less. To more easily achieve ultra-miniaturization and high capacitance, the first direction length the of the internal electrode (121 and 122) may be 0.6 μm or less, and may be 0.4 μm or less.

In this case, the first direction length the of the internal electrode (121 and 122) may be a concept including a first direction length the of at least one of the plurality of internal electrode (121 and 122), or may be a concept including a first direction length the of all of the internal electrode (121 and 122).

In this case, the first direction length the of the internal electrode (121 and 122) may mean a length, a distance, a size, a length, or the like of the internal electrode (121 and 122) in the first direction, or may mean a thickness of the internal electrode (121 and 122).

In this case, the first direction length the of the internal electrode (121 and 122) may be a concept including a first direction length the of at least one of the plurality of internal electrode (121 and 122), or may be a concept including a first direction length the of each of all internal electrode (121 and 122).

In addition, the first direction length the of the internal electrode (121 and 122) may mean a first direction average length the of one internal electrode (121 and 122), or may mean a first direction average length the of each of the plurality of internal electrode (121 and 122), or may mean a first direction average length the of the plurality of internal electrode (121 and 122).

The first direction average length the of the internal electrode (121 and 122) may be measured by scanning images of the first and second direction cross-sections of the body 110 with a scanning electron microscope (SEM) at 10,000× magnification. More specifically, the first average length the of one internal electrode (121 and 122) may be an average value calculated by measuring first direction lengths of one internal electrode at five (5) equally spaced points in the second direction in the scanned images. The five (5) equally spaced points may be designated in the capacitance forming portion Ac. In addition, when this average value measurement is extended to three internal electrode (121 and 122) to measure an average value, the first direction average length the of the plurality of internal electrode (121 and 122) may be further generalized.

In an embodiment of the present disclosure, a first direction length td of at least one of the plurality of dielectric layers 111 and a first direction length the of at least one of the plurality of internal electrode (121 and 122) may satisfy 2×te<td.

For example, a first direction length td of one dielectric layer 111 may be larger than twice a first direction length the of one internal electrode (121 and 122). In some embodiments, a first direction average length td of the plurality of dielectric layers 111 may be greater than twice a first direction average length the of the plurality of internal electrode (121 and 122).

Generally, reliability issues due to a decrease in breakdown voltage (BDV) under a high voltage environment may be a major issue for high-voltage electrical electronic components.

Therefore, to prevent a decrease in breakdown voltage under a high voltage environment, the first direction average length td of the dielectric layer 111 may be made greater than twice the first direction average length the of the internal electrode (121 and 122), thereby improving breakdown voltage characteristics.

When the first direction average length td of the dielectric layer 111 is equal to or less than twice the first direction average length the of the internal electrode (121 and 122), breakdown voltage may be decreased and a short circuit may occur between internal electrodes.

The body 110 may include a cover portion (112 and 113) disposed on first direction end-surfaces of the capacitance forming portion Ac.

Specifically, the cover portion (112 and 113) may include a first cover portion 112 disposed on one surface of the capacitance forming portion Ac in the first direction, and a second cover portion 113 disposed on the other surface of the capacitance forming portion Ac in the second direction. More specifically, for example, the cover portion (112 and 113) may include a first cover portion 112 disposed below the capacitance forming portion Ac in the first direction, and a second cover portion 113 disposed above the capacitance forming portion Ac in the first direction.

The first cover portion 112 and the second cover portion 113 may be formed by disposing or stacking a single second dielectric layer or two or more second dielectric layers on upper and lower surfaces of the capacitance forming portion Ac in the first direction, respectively, and may basically perform a role of preventing damage to the internal electrode (121 and 122) due to physical or chemical stress.

The first cover portion 112 and the second cover portion 113 may not include the internal electrode (121 and 122), and may include the same dielectric or ceramic material as the first dielectric layer 111 of the capacitance forming portion Ac. For example, the first cover portion 112 and the second cover portion 113 may include a dielectric or ceramic material, and for example, may include a barium titanate (BaTiO₃)-based material.

A first direction length tc of the cover portion (112 and 113) is not limited thereto, and the following description of the first direction length tc of the cover portion (112 and 113) may mean a first direction length tc of each of the first cover portion 112 and the second cover portion 113.

To more easily achieve miniaturization and high capacitance of the multilayer electronic component 100, the first direction length tc of the cover portion (112 and 113) may be 500 μm or less, 400 μm or less, 300 μm or less, 100 μm or less, 50 μm or less, 30 μm or less, or 20 μm or less.

In this case, the first direction length tc of the cover portion (112 and 113) may mean a first direction length of the cover portion (112 and 113).

In addition, the first direction length tc of the cover portion (112 and 113) may mean a first direction average length tc of each of the first and second cover portions 112 and 113, or may mean a first direction average length tc of the first and second cover portions 112 and 113.

The first direction average length tc of the cover portion (112 and 113) may be measured by scanning images of the first and second direction cross-sections of the body 110 with a scanning electron microscope (SEM) at 10,000× magnification. More specifically, average length tc in the first direction may mean an average value calculated by measuring first direction lengths at five (5) equally spaced points in the second direction in scanned images of the cover portion (112 and 113).

In addition, the first direction average length tc of the cover portion (112 and 113) measured by the above-described method may have a value substantially the same as the first direction average length of the cover portion (112 and 113) in the first and third direction cross-sections of the body 110.

The multilayer electronic component 100 may include a side margin region (114′ and 115′) which may be a third direction end region of the internal electrode (121 and 122).

More specifically, the side margin region (114′ and 115′) may include a first side margin region 114′ disposed between the internal electrode (121 and 122) and the fifth surface 5, and a second side margin region 115′ disposed between the internal electrode (121 and 122) and the sixth surface 6.

As illustrated, the side margin region (114′ and 115′) may mean a region between ends of the first and second internal electrodes 121 and 122 in the third direction and a boundary surface of the body 110, based on the first and third direction cross-sections of the body 110.

The side margin region (114′ and 115′) may refer to a ceramic green sheet region excluding the internal electrode (121 and 122), when an internal electrode paste is applied onto a ceramic green sheet applied to the capacitance forming portion Ac, except for a region in which the side margin region (114′ and 115′) will be.

The side margin region (114′ and 115′) may basically play a role in preventing damage to the internal electrode (121 and 122) due to physical or chemical stress.

The first side margin region 114′ and the second side margin region 115′ may not include the internal electrode (121 and 122), and may include the same material as the first dielectric layer 111 of the capacitance forming portion Ac. For example, the first side margin region 114′ and the second side margin region 115′ may include a dielectric material, and for example, may include a barium titanate (BaTiO₃)-based material.

A third direction length wm′ of the side margin region (114′ and 115′) does not need to be specifically limited, and the following description of the third direction length wm′ of the side margin region (114′ and 115′) may mean a third direction length wm′ of each of the first side margin region 114′ and the second side margin region 115′.

To improve bending strength and moisture resistance reliability of the multilayer electronic component 100, the third direction length wm′ of the side margin region (114′ and 115′) may be 100 μm or less, 50 μm or less, 30 μm or less, or 20 μm or less.

In this case, the third direction length wm′ of the side margin region (114′ and 115′) may mean a length, a distance, a size, a length, or the like of the side margin region (114′ and 115′) in the third direction, or may mean a width of the side margin region (114′ and 115′).

In addition, the third direction length wm′ of the side margin region (114′ and 115′) may mean a third direction average length wm′ of each of the first and second side margin regions (114′ and 115′), or may mean a third direction average length wm′ of the first and second side margin regions (114′ and 115′).

The third direction average length wm′ of the side margin region (114′ and 115′) may be measured by scanning images of the first and third direction cross-sections of the body 110 with a scanning electron microscope (SEM) at 10,000× magnification. More specifically, the third direction average length wm′ in the third direction may mean an average value calculated by measuring third direction lengths of one side margin region (114′ and 115′) at five (5) equally spaced points in the first direction in scanned images.

The multilayer electronic component 100 may include a side margin portion (114 and 115) disposed on third-direction end-surfaces of the body 110.

More specifically, the side margin portion (114 and 115) may include a first side margin portion 114 disposed on the fifth surface 5 of the body 110, and a second side margin portion 115 disposed on the sixth surface 6 of the body 110.

The side margin portion (114 and 115) may be formed by applying a conductive paste to a ceramic green sheet applied to the capacitance forming portion Ac, except for a portion in which the side margin portion (114 and 115) is to be formed, to form the internal electrode (121 and 122), and to suppress a step difference caused by the internal electrode (121 and 122), the internal electrode (121 and 122) after stacking may be cut to be exposed to the fifth and sixth surfaces 5 and 6 of the body 110, and disposing or stacking then a single third dielectric layer or two or more third dielectric layers on both end-surfaces of the capacitance forming portion Ac in the third direction.

The side margin portion (114 and 115) may basically play a role in preventing damage to the internal electrode (121 and 122) due to physical or chemical stress.

The first side margin portion 114 and the second side margin portion 115 may not include the internal electrode (121 and 122), and may include the same dielectric or ceramic material as the first dielectric layer 111. For example, the first side margin portion 114 and the second side margin portion 115 may include a dielectric or ceramic material, and for example, may include a barium titanate (BaTiO₃)-based material.

A third direction length wm of the side margin portion (114 and 115) is not limited thereto, and the following description of the third direction length wm of the side margin portion (114 and 115) may mean a third direction length wm of each of the first side margin portion 114 and the second side margin portion 115.

To improve bending strength and moisture resistance reliability of the multilayer electronic component 100, the third direction length wm of the side margin portion (114 and 115) may be 100 μm or less, 50 μm or less, 30 μm or less, or 20 μm or less.

In this case, the third direction length wm of the side margin portion (114 and 115) may mean a length, a distance, a size, a length, or the like of the side margin portion (114 and 115) in the third direction, or may mean a width of the side margin portion (114 and 115).

In addition, the third direction length wm of the side margin portion (114 and 115) may mean a third direction average length wm of each of the first and second side margin portion (114 and 115), or may mean a third direction average length wm of the first and second side margin portion (114 and 115).

The third direction average length wm of the side margin portion (114 and 115) may be measured by scanning images of the first and third direction cross-sections of the body 110 with a scanning electron microscope (SEM) at 10,000× magnification. More specifically, the third direction average length wm in the third direction may mean an average value calculated by measuring third direction lengths of one side margin portion (114 and 115) at five (5) equally spaced points in the first direction in scanned images.

In an embodiment of the present disclosure, a structure in which the multilayer electronic component 100 has two external electrodes (131 and 132) is illustrated, but the number, shapes, or the like of external electrodes (131 and 132) may be changed depending on a shape of the internal electrode (121 and 122) or other purposes.

The external electrode (131 and 132) may be disposed on the body 110, and may be connected to the internal electrode (121 and 122).

More specifically, the external electrode (131 and 132) may include first and second external electrodes 131 and 132 disposed on the third and fourth surfaces 3 and 4 of the body 110, respectively, and connected to the first and second internal electrodes 121 and 122, respectively. For example, the first external electrode 131 may be disposed on the third surface 3 of the body, and may be connected to the first internal electrode 121, and the second external electrode 132 may be disposed on the fourth surface 4 of the body, and may be connected to the second internal electrode 122.

In addition, the external electrode (131 and 132) may be disposed to extend on portions of the first and second surfaces 1 and 2 of the body 110, or may be disposed to extend on portions of the fifth and sixth surfaces 5 and 6 of the body 110. For example, the first external electrode 131 may be disposed on portions of the first, second, fifth, and sixth surfaces 1, 2, 5, and 6 of the body 110, and the second external electrode 132 may be disposed on portions of the first, second, fifth, and sixth surfaces 1, 2, 5, and 6 of the body 110.

In this case, each region of the first and second external electrodes 131 and 132 disposed to extend on portions of the first and second surfaces 1 and 2 may be referred to as a band portion, and the band portion of the first external electrode 131 may be referred to as a first band portion, and the band portion of the second external electrode 132 may be referred to as a second band portion.

More specifically, the first external electrode 131 may include a first band portion, which may be a region disposed to extend to portions of the first and second surfaces 1 and 2, and a region disposed to extend to a portion of the first surface 1, among the first band portions of the first external electrode 131, may be referred to as a 1-1 band portion, and a region disposed to extend to a portion of the second surface 2 may be referred to as a 1-2 band portion.

The second external electrode 132 may include a second band portion, which may be a region disposed to extend to portions of the first and second surfaces 1 and 2, and a region disposed to extend to a portion of the first surface 1, among the second band portions of the second external electrode 132, may be referred to as a 2-1 band portion, and a region disposed to extend to a portion of the second surface 2 may be referred to as a 2-2 band portion.

In the present disclosure, unless specifically contradictory, the description of the band portion may correspond to the description of each of the first and second band portions, the description of the first band portion may correspond to the description of each of the 1-1 band portion and the 1-2 band portion, and the description of the second band portion may correspond to the description of each of the 2-1 band portion and the 2-2 band portion. Furthermore, the description of the band portion may correspond to the description of each of the 1-1 band portion, the 1-2 band portion, the 2-1 band portion, and the 2-2 band portion.

The band portion may be disposed on portions of the first and second surfaces 1 and 2, and in this case, the first and second surfaces 1 and 2 may mean a surface of the body 110 located between the extension line EL3 of the third surface 3 and the extension line ELA of the fourth surface 4. In this case, the surface of the body 110 located between the extension line EL3 of the third surface 3 and the extension line ELA of the fourth surface 4 is not limited to the third surface 3 or fourth surface 4, substantially parallel to each other, and may be a concept including a corner of the body 110.

The external electrode (131 and 132) may be formed of any material as long as they have electrical conductivity, such as metal or the like, and a specific material may be determined in consideration of electrical characteristics, structural stability, or the like, and may further have a multilayer structure.

For example, the external electrode (131 and 132) may include a first electrode layer (131a and 132a) disposed on the body 110, and a second electrode layer (131b and 132b) disposed on the first electrode layer (131a and 132a). Furthermore, a third electrode layer (131c and 132c) disposed on the second electrode layer (131b and 132b) may be included. In this case, it is preferable that the first to third electrode layers correspond to layers that may be distinguished from each other. However, it is not limited thereto, and may be distinguished according to an order of a manufacturing process, and at least some layers among the first to third electrode layers may not be distinguished from each other, and may be observed as one layer.

In the present disclosure, being “distinguished” may mean that two layers may be distinguished due to physical differences, chemical differences, and/or simple optical differences, and is not limited thereto, but distinction between layers may be distinguished by the presence or absence of an “interface.” The interface may mean a surface on which two layers contacting each other may be distinguishable from each other, and may mean, for example, a state distinguishable through differences in components, such as EDS analysis using equipment such as a scanning electron microscope (SEM) or the like (SEM, TEM, STEM).

The first electrode layer (131a and 132a) and the second electrode layer (131b and 132b) may be formed by transferring a sheet including a conductive metal onto the body 110, or may be formed by applying and then sintering a conductive paste for an external electrode including a conductive metal to the body 110, or may be formed by dipping the body 110 into a conductive paste for an external electrode including a conductive metal, but is not limited thereto.

For a more specific example of the electrode layers (131a, 132a, 131b, and 132b), the electrode layers (131a, 132a, 131b, and 132b) may have a two-layer structure including the first electrode layer (131a and 132a) and the second electrode layer (131b and 132b).

More specifically, the external electrode (131 and 132) may include the first electrode layer (131a and 132a) including a first conductive metal and glass, and the second electrode layer (131b and 132b), distinguished from the first electrode layer (131a and 132a), disposed on the first electrode layer (131a and 132a), and including a second conductive metal and a resin.

A material having excellent electrical conductivity may be used as the conductive metal included in the electrode layers (131a, 132a, 131b, and 132b). For example, the conductive metal may include one or more selected from the group consisting of nickel (Ni), copper (Cu), palladium (Pd), silver (Ag), gold (Au), platinum (Pt), tin (Sn), tungsten (W), titanium (Ti), and an alloy thereof, but is not limited thereto.

In this case, the conductive metal included in the first electrode layer (131a and 132a) may be referred to as a first conductive metal, and the conductive metal included in the second electrode layer (131b and 132b) may be referred to as a second conductive metal. In this case, the first conductive metal and the second conductive metal may be the same or different from each other, and in a case in which a plurality of conductive metals are included, only some thereof may include the same conductive metal, but is not limited thereto.

The glass included in the first electrode layer (131a and 132a) may play a role of improving bonding properties with the body 110, and the resin included in the second electrode layer (131b and 132b) may play a role of improving bending strength.

The first conductive metal included in the first electrode layer (131a and 132a) may play a role of electrically connecting with the internal electrode (121 and 122).

The first conductive metal included in the first electrode layer (131a and 132a) is not particularly limited as long as it is a material that may be electrically connected with the internal electrode (121 and 122), and for example, may include at least one of nickel (Ni), copper (Cu), palladium (Pd), silver (Ag), gold (Au), platinum (Pt), tin (Sn), tungsten (W), titanium (Ti), or an alloy thereof.

The first electrode layer (131a and 132a) may be disposed on the third and fourth surfaces 3 and 4, and may be disposed to extend to portions of the first and second surfaces 1 and 2. For example, the first electrode layer (131a and 132a) may be disposed on the band portion of the external electrode (131 and 132).

Specifically, the first electrode layer 131a of the first external electrode 131 may be disposed on the third surface 3, and may be disposed to extend to portions of the first and second surfaces 1 and 2, and the first electrode layer 132a of the second external electrode 132 may be disposed on the fourth surface 4, and may be disposed to extend to portions of the first and second surfaces 1 and 2. For example, the first electrode layer 131a of the first external electrode 131 may be disposed in the first band portion, and more specifically, the first electrode layer 131a of the first external electrode 131 may be disposed in the 1-1 band portion and the 1-2 band portion. The second electrode layer 132a of the second external electrode 132 may be disposed in the second band portion, and more specifically, the first electrode layer 132a of the second external electrode 132 may be disposed in the 2-1 band portion and the 2-2 band portion.

The second conductive metal included in the second electrode layer (131b and 132b) may perform a role of electrically connecting with the first electrode layer (131a and 132a).

The second conductive metal included in the second electrode layer (131b and 132b) is not particularly limited as long as it is a material that may be electrically connected with the first electrode layer (131a and 132a), and may include at least one of nickel (Ni), copper (Cu), palladium (Pd), silver (Ag), gold (Au), platinum (Pt), tin (Sn), tungsten (W), titanium (Ti), or an alloy thereof.

The second electrode layer (131b and 132b) may be disposed on the first electrode layer (131a and 132a), and may be disposed to cover the first electrode layer (131a and 132a).

In this case, a phrase that the second electrode layer (131b and 132b) may be “disposed to cover” the first electrode layer (131a and 132a) may mean that the second electrode layer (131b and 132b) may be disposed on the first electrode layer (131a and 132a) such that the first electrode layer (131a and 132a) may not be exposed to the outside, and may mean that the second electrode layer (131b and 132b) may be disposed such that an end of the first electrode layer (131a and 132a) may not be exposed to the outside, and may be extended to portions of the first and second surfaces 1 and 2 in which the first electrode layer (131a and 132a) may not be disposed, and may be disposed to directly contact the body 110.

Specifically, the second electrode layer (131b and 132b) may be disposed on the third and fourth surfaces 3 and 4 and extended to portions of the first and second surfaces 1 and 2. For example, the second electrode layer (131b and 132b) may be disposed on the band portion of the external electrode (131 and 132).

More specifically, the second electrode layer 131b of the first external electrode 131 may be disposed on the first electrode layer 131a of the first external electrode 131 disposed on the third surface 3, and may be disposed on the first electrode layer 131a of the first external electrode 131 extended to portions of the first and second surfaces 1 and 2, and may furthermore be disposed to extend to portions of the first and second surfaces 1 and 2 on which the first electrode layer 131a of the first external electrode 131 is not disposed. For example, the band portion of the first external electrode 131 may include a first electrode layer 131a of the first external electrode 131 disposed to extend to portions of the first and second surfaces 1 and 2, and a second electrode layer 131b disposed to cover the first electrode layer 131a of the first external electrode 131.

The second electrode layer 132b of the second external electrode 132 may be disposed on the first electrode layer 132a of the second external electrode 132 disposed on the fourth surface 4, and may be disposed on the first electrode layer 132a of the second external electrode 132 extended to portions of the first and second surfaces 1 and 2, and may furthermore be disposed to extend to portions of the first and second surfaces 1 and 2 in which the first electrode layer 132a of the second external electrode 132 is not disposed. For example, the band portion of the second external electrode 132 may include a first electrode layer 132a of the second external electrode 132 disposed to extend to portions of the first and second surfaces 1 and 2, and a second electrode layer 132b disposed to cover the first electrode layer 132a of the second external electrode 132.

For example, the second electrode layer 131b of the first external electrode 131 may be disposed in the first band portion, and more specifically, the second electrode layer 131b of the first external electrode 131 may be disposed in the 1-1 band portion and the 1-2 band portion. The second electrode layer 132b of the second external electrode 132 may be disposed in the second band portion, and more specifically, the second electrode layer 132b of the second external electrode 132 may be disposed in the 2-1 band portion and the 2-2 band portion.

The second conductive metal included in the second electrode layer (131b and 132b) may include at least one of spherical particles or flake-shaped particles. For example, the second conductive metal may be composed of only the flake-shaped particles, only the spherical particles, or a mixed form of the spherical particles and the flake-shaped particles.

In this case, the spherical particles may include shapes that may not be completely spherical, for example, shapes having a length ratio of a major axis to a minor axis (major axis/minor axis) of 1.45 or less. The flake-shaped particles refer to particles having a flat and elongated shape, and is not particularly limited, but may have, for example, a length ratio of a major axis to a minor axis (major axis/minor axis) of 1.95 or more. Lengths of the major and minor axes of the spherical particle and the flake-shaped particle may be measured from images obtained by scanning cross-sections in the first and second directions cut from a central portion of the multilayer electronic component in the third direction with a scanning electron microscope (SEM) or the like (SEM, TEM, STEM).

The resin included in the second electrode layer (131b and 132b) may play a role in securing bonding properties and absorbing shock, and is not particularly limited as long as it is mixed with the second conductive metal particle to make a paste, and may include, for example, an epoxy-based resin.

In addition, the second electrode layer (131b and 132b) may include an intermetallic compound.

The intermetallic compound may be included to further improve electrical connectivity with the first electrode layer (131a and 132a). The intermetallic compound may serve to improve electrical connectivity by connecting a plurality of metal particles, and may serve to surround and connect the plurality of metal particles to each other.

In this case, the intermetallic compound may include a metal having a melting point, lower than a curing temperature of a resin. For example, since the intermetallic compound includes a metal having a melting point, lower than a curing temperature of a resin, the metal having a melting point, lower than a curing temperature of a resin, may melt during a drying process and a curing process to form some of metal particles and the intermetallic compound, to surround the metal particles. In this case, the intermetallic compound may include a low melting point metal of 300° C. or less. More specifically, for example, the intermetallic compound may include tin (Sn) having a melting point of 213 to 220° C. During the drying process and the curing process, tin (Sn) may be melted, and the melted tin (Sn) may wet the third conductive metal particles having a high melting point, such as Ag, Ni, or Cu, by capillary action, and may react with a portion of Ag, Ni, or Cu metal particles to form intermetallic compounds such as Ag₃Sn, Ni₃Sn₄, Cu₆Sn₅, Cu₃Sn, or the like. Ag, Ni, or Cu that did not participate in the reaction may remain as metal particles.

Therefore, the plurality of metal particles may include one or more selected from the group consisting of Ag, Ni, and Cu, and the intermetallic compound may include one or more selected from the group consisting of Ag₃Sn, Ni₃Sn₄, Cu₆Sn₅, and Cu₃Sn.

The third electrode layer (131c and 132c) may play a role in improving mounting characteristics, and the third electrode layer (131c and 132c) may be a plating layer formed on the second electrode layer (131b and 132b) by a plating method, but is not limited thereto.

A type of the third electrode layer (131c and 132c) is not particularly limited, and may include, for example, at least one of nickel (Ni), tin (Sn), silver (Ag), palladium (Pd), or an alloy thereof.

The third electrode layer (131c and 132c) may be a single layer or may be a plurality of layers.

More specifically, for example, the third electrode layer may include a nickel (Ni) electrode layer or a tin (Sn) electrode layer, and may be in a configuration in which the nickel (Ni) electrode layer and the tin (Sn) electrode layer may be sequentially formed on the second electrode layer (131b and 132b), or may be in a configuration in which the tin (Sn) electrode layer, the nickel (Ni) electrode layer, and the tin (Sn) electrode layer are sequentially formed. In addition, the third electrode layer (131c and 132c) may include a plurality of nickel (Ni) electrode layers and/or a plurality of tin (Sn) electrode layers.

In some embodiments of the present disclosure, a ratio (BW/BL) of a second direction maximum length BW of the band portion relative to a second direction average length BL of the body 110 may satisfy 14.9%≤BW/BL<50.0%.

A method for obtaining the second direction average length BL of the body 110 may be omitted as it has been described above, and a method for obtaining the second direction maximum length BW of the band portion may be as follows, but is not limited thereto. In this case, the second direction maximum length BW of the band portion may mean a second direction maximum length BW of each of the 1-1 band portion, the 1-2 band portion, the 2-1 band portion, and the 2-2 band portion.

The second direction maximum length BW of the band portion may be a second direction maximum length BW of the band portion disposed on the first surface 1 or the second surface 2 of the body. More specifically, the second direction maximum length BW of the band portion BW may be a distance between the extension line EL3 of the third surface 3 or the extension line ELA of the fourth surface 4, which may be one end of the band portion in the second direction, and an end point of the band portion, which may be the other end of the band portion in the second direction, disposed on the first surface 1 or the second surface 2 of the body. The second direction maximum length BW of the band portion BW may be a straight line distance in the second direction.

The ratio (BW/BL) of the second direction maximum length BW of the band portion relative to the second direction average length BL of the body 110 may satisfy 14.9%≤BW/BL<50.0% to minimize bending stress applied to the body 110 by external vibration, impact, or the like, thereby preventing cracks from being generated in the body 110, and thus bending strength characteristics may be improved.

A lower limit value of the ratio (BW/BL) of the second direction maximum length BW of the band portion relative to the second direction average length BL of the body 110 may be 14.9%, and may be 15.7%.

In addition, the second direction maximum length BW of the band portion is not particularly limited for improving bending strength characteristics, but may be 850 μm or more (850 μm≤BW), and may be 900 μm or more (900 μm≤BW).

When the ratio (BW/BL) of the second direction maximum length BW of the band portion relative to the second direction average length BL of the body is less than 14.9% (BW/BL<14.9%), bending strength characteristics may not be sufficiently improved, and there may be a concern that cracks is generated in the body 110.

To improve bending strength characteristics, an upper limit value of the ratio (BW/BL) of the second direction maximum length BW of the band portion relative to the second direction average length BL of the body is not particularly limited, but, to prevent the first and second external electrodes 131 and 132 from being electrically connected to each other, may satisfy BW/BL<50%, and since an arc discharge may occur between adjacent band portions depending on usage environment of the multilayer electronic component 100, to prevent this, BW/BL≤25% may be satisfied.

As described above, the band portion may include a first electrode layer (131a and 132a) and a second electrode layer (131b and 132b) disposed to cover the first electrode layer (131a and 132a).

In the band portion, a region of the second electrode layer (131b and 132b) disposed to be in direct contact with the body 110 may be referred to as a first region, a region of the first electrode layer (131a and 132a) disposed to be in direct contact with the body 110 may be referred to as a second region, and a region of the second electrode layer (131b and 132b) disposed on the first electrode layer (131a and 132a) may be referred to as a third region.

In this case, an interface in which the second electrode layer (131b and 132b) and the body 110 come into contact in the first region may be referred to as a first interface, an interface in which the first electrode layer (131a and 132a) and the body 110 come into contact in the second region may be referred to as a second interface, and an interface in which the first electrode layer (131a and 132a) and the second electrode layer (131b and 132b) come into contact in the third region may be referred to as a third interface.

In some embodiments of the present disclosure, an average surface roughness (Ra1) of the body 110 in the first region may satisfy 0 nm<Ra1≤158 nm. For example, an average surface roughness (Ra1) of the body 110 at the first interface, which may be an interface in which the second electrode layer (131b and 132b) and the body 110 come into contact, may satisfy 0 nm<Ra1≤158 nm.

In the present disclosure, the “average surface roughness (Ra)” may be a value by calculating roughness of a surface of the body 110 on the surface, and may mean roughness of the body 110 by calculating an average value based on a virtual center line of roughness.

Surface roughness may be a degree of fine unevenness that occurs on a surface when processing a surface of a specific material, and may be also called surface roughness. Surface roughness generally refers to what occurs due to tools used for processing, suitability of a processing method, scratches on a surface, rust, or the like.

An average surface roughness (Ra) may mean a value obtained by extracting only a reference length in a direction of an average line from a roughness curve obtained by a roughness measuring device, taking an X-axis in the direction of the average line of this extracted portion, and a Y-axis in a vertical magnification direction, and then obtaining a roughness curve corresponding equation f(x), and may mean a value obtained according to the following equation 1, and a unit thereof may be micrometer (μm) or nanometer (nm).

In cases in which it is difficult to measure roughness using the roughness measuring device, the roughness curve corresponding equation f(x) of the above-described method may be obtained based on an image taken of a cross-section to be measured, for example, the first to third regions in the present disclosure, using a scanning electron microscope (SEM) or the like (SEM, TEM, STEM), and then obtaining the roughness according to the following equation 1.

$$Ra = \frac{1}{l} {\int }_{0}^{l} \vert f ( x ) \vert dx \qquad [ Equation 1 ]$$

Another method for calculating the average surface roughness (Ra) may be to measure each maximum distance of surface roughness (e.g., r₁, r₂, r₃, . . . , rₙ) based on a virtual center line of the surface roughness, and then calculate an average value of each distance as in the following equation 2, to obtain the average surface roughness (Ra) using the calculated value.

$$Average Surface Roughness = \frac{\vert {r}_{1} \vert + \vert {r}_{2} \vert + \vert {r}_{3} \vert + … + \vert {r}_{n} \vert}{n} \qquad [ Equation 2 ]$$

The average surface roughness (Ra1) of the body 110 in the first region may satisfy 0 nm<Ra1≤158 nm to minimize an anchoring effect between the second electrode layer (131b and 132b) and the body 110, thereby inducing peel-off between the second electrode layer (131b and 132b) and the body 110, thereby minimizing bending stress applied to the body 110, thereby preventing cracks from being generated. In addition, even though cracks are generated, the capacitance forming portion Ac may not be affected, thereby preventing reliability of the multilayer electronic component 100 from being deteriorated.

When the average surface roughness (Ra1) of the body 110 in the first region is 158 nm<Ra1, there may be a concern that cracks are generated in the body 110 because peel-off does not occur due to the anchoring effect between the second electrode layer (131b and 132b) and the body 110.

A lower limit value of the average surface roughness (Ra1) of the body 110 in the first region is not particularly limited as long as peel-off occurs between the second electrode layer (131b and 132b) and the body 110, and for example, 0 nm<Ra1 may be satisfied.

In addition, an average surface roughness (Ra2) of the body 110 in the second region may satisfy 158 nm<Ra2. For example, an average surface roughness (Ra2) of the body 110 on the second interface, which may be an interface in which the first electrode layer (131a and 132a) and the body 110 come into contact, may satisfy 158 nm<Ra2.

The average surface roughness (Ra2) of the body 110 in the second region may satisfy 158 nm<Ra2 to maintain an anchoring effect between the first electrode layer (131a and 132a) and the body 110, thereby improving bonding strength between the first electrode layer (131a and 132a) and the body 110, thereby preventing delamination between the first electrode layer (131a and 132a) and the body 110, thereby inhibiting external moisture penetration, thereby improving moisture resistance reliability of the multilayer electronic component 100.

When the average surface roughness (Ra2) of the body 110 in the second region is Ra2≤158 nm, the anchoring effect between the first electrode layer (131a and 132a) and the body 110 may be insufficient such that peel-off occurs, and there may be a concern that moisture resistance reliability of the multilayer electronic component 100 is reduced.

An upper limit value of the average surface roughness (Ra2) of the body 110 in the second region is not particularly limited as long as delamination does not occur between the first electrode layer (131a and 132a) and the body 110, and may be, for example, 5 μm or less, 4 μm or less, 3 μm or less, 2 μm or less, or 1 μm or less.

In some embodiments of the present disclosure, an average surface roughness (Ra3) of the first electrode layer (131a and 132a) in the third region may satisfy 0 nm<Ra3≤158 nm. For example, an average surface roughness (Ra3) of the first electrode layer (131a and 132a) on the third interface, which may be an interface in which the first electrode layer (131a and 132a) and the second electrode layer (131b and 132b) come into contact, may satisfy 0 nm<Ra3≤158 nm.

The average surface roughness (Ra3) of the first electrode layer (131a and 132a) in the third region may satisfy 0 nm<Ra3≤158 nm to minimize an anchoring effect between the first electrode layer (131a and 132a) and the second electrode layer (131b and 132b), thereby inducing peel-off between the first electrode layer (131a and 132a) and the second electrode layer (131b and 132b), thereby minimizing bending stress applied to the body 110, thereby preventing cracks from being generated. In addition, even though cracks are generated, the capacitance forming portion Ac may not be affected, thereby preventing reliability of the multilayer electronic component 100 from being deteriorated.

When the average surface roughness (Ra3) of the first electrode layer (131a and 132a) in the third region is 158 nm<Ra3, there may be a concern that cracks are generated in the body 110 because peel-off does not occur due to the anchoring effect between the first electrode layer (131a and 132a) and the second electrode layer (131b and 132b).

A lower limit value of the average surface roughness (Ra3) of the first electrode layer (131a and 132a) in the third region is not particularly limited as long as peel-off occurs between the first electrode layer (131a and 132a) and the second electrode layer (131b and 132b), and for example, 0 nm<Ra3 may be satisfied.

A size of the multilayer electronic component 100 is not limited thereto.

To minimize occurrence of cracks due to external impact among sizes of multilayer electronic components 100 vulnerable to bending strength, effects according to the present disclosure may be more prominent in multilayer electronic components 100 having a size of 3216 (length×width: 3.2 mm×1.6 mm, length and width satisfy an error of +10%) or larger (sizes 3216, 3225, 4520, 4532, 5750, 5763, etc.).

Hereinafter, the present disclosure will be described in more detail through test examples, but this may be to help a specific understanding of the invention, and the scope of the present disclosure may not be limited by the test examples.

### (Test Example)

The following Table 1 describes a ratio of a second direction maximum length BW of a band portion relative to a second direction average length BL of a body and an average surface roughness (Ra1) of the body in a region in which a second electrode layer and the body come into contact, and the number of sample chips in which bending cracks and peel-offs occurred after bending failure evaluation was performed.

For each test example, 30 sample chips were manufactured, and the number of sample chips in which bending cracks and peel-offs occurred was counted when bending strength evaluation was performed.

For the bending strength evaluation, after the sample chips were mounted on a substrate, a bending strength measuring device (R340) was used to apply different forces to the substrate step by step to bend the substrate, and the substrate was set to bend 1 mm more at each step, and each step was maintained for 5 seconds. The bending strength evaluation was performed in steps from 2 mm to 8 mm.

The following [Table 2] counts and describes the number of sample chips in which peel-off occurred at each step during bending strength evaluation of Test Examples 1 to 4.

TABLE 1

| | BW/BL | | | |
|---|---|---|---|---|
| | (%) | Ra1 (nm) | Cracks | Peel-Off |
| Test Example 1 | 14.9% | More than 158 nm | 1/30 | 21/30 |
| Test Example 2 | 14.9% | More than 0 nm | 0/30 | 18/30 |
| | | Less than 158 nm | | |
| Test Example 3 | 14.9% | 158 nm | 0/30 | 18/30 |
| Test Example 4 | 15.7% | 158 nm | 0/30 | 7/30 |

TABLE 2

| | 2 mm | 3 mm | 4 mm | 5 mm | 6 mm | 7 mm | 8 mm | Total |
|---|---|---|---|---|---|---|---|---|
| Test Example | 0 | 0 | 0 | 1 | 3 | 10 | 7 | 21 |
| 1 | | | | | | | | |
| Test Example | 0 | 0 | 0 | 1 | 5 | 6 | 6 | 18 |
| 2 | | | | | | | | |
| Test Example | 0 | 0 | 0 | 0 | 8 | 7 | 3 | 18 |
| 3 | | | | | | | | |
| Test Example | 0 | 0 | 0 | 0 | 3 | 2 | 2 | 7 |
| 4 | | | | | | | | |

In Test Example 1 in which a ratio of a second direction maximum length BW of a band portion relative to a second direction average length BL of a body satisfied 14.9%≤BW/BL, but an average surface roughness (Ra1) of the body in a region in which a second electrode layer and the body come into contact satisfied 158 nm<Ra1, there was 1 sample chip in which cracks occurred, and the number of sample chips in which peel-off occurred was also 21, which was relatively large. In Test Examples 2 to 4 in which a ratio of a second direction maximum length BW of a band portion relative to a second direction average length BL of a body satisfied 14.9%≤BW/BL and an average surface roughness (Ra1) of the body in a region in which a second electrode layer and the body come into contact satisfied 0<Ra1≤158 nm, there was no sample chip (0) in which cracks occurred, and the number of sample chips in which peel-off occurred was also 18, 18, and 7, respectively, which were relatively small. In addition, in Test Example 4 in which BW/BL was 15.7%, the number of sample chips in which peel-off occurred was 7, which was the lowest, and when evaluating bending strength, peel-off occurred from a bending strength of 6 mm, which shows that it has the best bending strength.

In addition, the expression ‘an embodiment’ used in this specification does not mean the same embodiment, and may be provided to emphasize and describe different unique characteristics. However, an embodiment presented above may not be excluded from being implemented in combination with features of another embodiment. For example, although the description in a specific embodiment is not described in another example, it may be understood as an explanation related to another example, unless otherwise described or contradicted by the other embodiment.

The terms used in this disclosure are used only to illustrate various examples and are not intended to limit the present inventive concept. Singular expressions include plural expressions unless the context clearly dictates otherwise.

One of various effects of the present disclosure is to improve bending strength of a multilayer electronic component.

One of various effects of the present disclosure is to enhance impact resistance of a multilayer electronic component.

Various advantages and effects of the present disclosure are not limited to the above-described contents, and can be more easily understood in the process of explaining specific embodiments of the present disclosure.

While example embodiments have been illustrated and described above, it will be apparent to those skilled in the art that modifications and variations could be made without departing from the scope of the present disclosure as defined by the appended claims.

What is claimed is:

1. A multilayer electronic component comprising:
a body including a dielectric layer and an internal electrode alternately disposed with the dielectric layer in a first direction, and including first and second surfaces opposing each other in the first direction, third and fourth surfaces connected to the first and second surfaces and opposing each other in a second direction, and fifth and sixth surfaces connected to the first to fourth surfaces and opposing each other in a third direction; and
an external electrode including a first electrode layer disposed on the body and connected to the internal electrode, and a second electrode layer disposed on the first electrode layer,
wherein the external electrode includes a first external electrode disposed on the third surface and extending onto a portion of the first surface and a portion of the second surface, and a second external electrode disposed on the fourth surface and extending onto a portion of the first surface and a portion of the second surface, and, when regions of the first and second external electrodes extended to the portions of the first and second surfaces are referred to as band portions, a ratio (BW/BL) of a second direction maximum length BW of each of the band portions relative to a second direction average length BL of the body satisfies 14.9%≤BW/BL<50.0%, and
each of the band portions includes a first region in which the second electrode layer is in contact with the first or second surface of the body, and an average surface roughness (Ra1) of the body in the first region satisfies 0 nm<Ra1≤158 nm.

2. The multilayer electronic component of claim 1, wherein each of the band portions includes a second region in which the first electrode layer is in contact with the first or second surface of the body, and an average surface roughness (Ra2) of the body in the second region satisfies 158 nm<Ra2.

3. The multilayer electronic component of claim 1, wherein each of the band portions includes a third region in which the second electrode layer is in contact with the first electrode layer, and an average surface roughness (Ra3) of the first electrode layer in the third region satisfies 0<Ra3≤158 nm.

4. The multilayer electronic component of claim 1, wherein BW satisfies 850 μm≤BW.

5. The multilayer electronic component of claim 1, wherein the first electrode layer includes a first conductive metal and glass.

6. The multilayer electronic component of claim 1, wherein the second electrode layer includes a second conductive metal and a resin.

7. The multilayer electronic component of claim 1, wherein the external electrode includes a third electrode layer disposed on the second electrode layer.

8. The multilayer electronic component of claim 1, wherein a first direction average length (td) of the dielectric layer and a first direction average length (the) of the internal electrode satisfy 2×te<td.

9. The multilayer electronic component of claim 1, wherein a second direction average length is 3.2 mm or more, and a third direction average length is 1.6 mm or more.
